(19) United States
(12) Patent Application Publication
(10) Pub. No.: US 2013/0189467 A1
(43) Pub. Date: Jul. 25, 2013

(54) ADHESIVE COMPOSITION AND ADHESIVE COMPRISING THE SAME

(71) Applicant: PIONEER MATERIAL PRECISION TECH CO., LTD., New Taipei City (TW)

(72) Inventors: Yong-Qi Cai, New Taipei City (TW); Yuan-Shun Tsai, New Taipei City (TW); Wei-Ting Lin, Taipei City (TW)

(73) Assignee: PIONEER MATERIAL PRECISION TECH CO., LTD., New Taipei City (TW)

(21) Appl. No.: 13/744,427

(22) Filed: Jan. 18, 2013

Related U.S. Application Data
(60) Provisional application No. 61/588,661, filed on Jan. 20, 2012.

(51) Int. Cl. C09J 183/04

(52) U.S. Cl. CPC C09J 183/04
USPC 428/40.4; 428/355 R; 428/328; 428/323; 428/40.9; 428/354; 428/344; 442/70; 428/339

(57) ABSTRACT

Adhesives with a specific viscose component to provide good thermal conductivity, insulation and flame retardant and high temperature resistant is provided. The adhesive composition form may be single-sided or double-sided with a substrate or not. The substrate may be metal foil, glass fiber, thermal pad or organic polymers. Adhesive composition includes polymerized siloxane, metal hydroxides, and metal oxides. Nitrides, aluminum powder or coupling agent may be added. The coupling agent is specially used in non-silica resin substrate, which enhances the adhesion to substrate surface. Optionally, the adhesive may include a release film.

### CROSS REFERENCE TO RELATED APPLICATIONS

This application claims the benefit of U.S. Provisional Application Ser. No. 61/588,661, filed Jan. 20, 2012.

### BACKGROUND OF THE INVENTION

1. Field of the Invention

The present invention generally relates to a novel composition, which is thermal conductive, electric insulating, high temperature resistant and flame retardant as well as an adhesive containing this composition. In particular, the present invention is directed to a composition which is rated to UL 94V-0 standard specification, as well as an adhesive containing this composition. Both the composition and the adhesive are thermal conductive, electric insulating, high temperature resistant and flame retardant at the same time, and suitable to serve as a single-sided or double-sided adhesive.

2. Description of the Prior Art

The general purpose of an adhesive composition is to make two objects firmly adhere to together, so it is widely used. In some circumstances, the adhesive composition needs more practical usages. For example, a special adhesive composition is used in the computer motherboards. On one hand, the adhesive composition is needed to make the heating source and the heat-dissipating device firmly adhered together by the adhesive composition. On the other hand, the adhesive composition is also needed to conduct the heat coming from the heat source to the heat-dissipating device.

There are already double-sided adhesives, which are commercially available and known as thermal conductive adhesives, to conduct the heat coming from the heat source to the heat-dissipating device. These thermal conductive and double-sided adhesives are generally a substrate coated with acrylic-based adhesive to adhere the heat source to the heat-dissipating device. However, since the main ingredients of the adhesive are acrylic-based organic compounds, these thermally conductive double-sided adhesives have drawbacks. For example, it is neither high temperature resistant (not over 100° C. in general) nor flame retardant. Also, the thermal conductive property is not good.

In addition, although there are also commercially available double-sided and thermal conductive adhesives with silicone-coated substrates, and they are temperature resistant (not over 180° C. in general), but these silicone-based adhesives are not flame retardant. Also, although there are also some commercially available thermal conductive adhesives of very small thickness, this material is obviously not strong enough due to its insufficient thickness.

Accordingly, it is still needed to provide a novel composition and an adhesive which are thermal conductive, electric insulating, high temperature resistant and flame retardant. In particular, they are rated to the international standard of UL 94V-0, in order to meet the strict and stringent industrial demands.

### SUMMARY OF THE INVENTION

In view of the above, the present invention proposes a thermal conductive, electric insulating, high temperature resistant and flame retardant composition as well as an adhesive containing the composition. The features of the composition and the adhesive of the present invention resides in that they are not only highly thermal conductive and electric insulating, but they are also rated to the specification of UL 94V-0 standard, which is fully able to meet the strict and stringent industrial demands. Optionally, the composition and the adhesive of the present invention may have an extremely small thickness or include a release film, to be a single-sided or double-sided product.

In a first aspect, the present invention proposes an adhesive which is thermal conductive, electric insulating, high temperature resistant and flame retardant. The thermal conductive, electric insulating, high temperature resistant and flame retardant adhesive of the present invention includes a substrate and an adhesive composition. The substrate may be a metal foil, glass fiber, an organic polymer, or a thermal conductive silicone sheet. In a second aspect, the present invention also proposes an adhesive composition which is thermal conductive, electric insulating, high temperature resistant and flame retardant. The adhesive composition includes a siloxane resin, a metal hydroxide and a metal oxide, or optionally needed nitride or aluminum powder, as well as a coupling agent serving as an adhesion enhancer when a silicon-free substrate is utilized.

The siloxane resin is 10% to 90% (weight percent, wt.) of the total adhesive composition. The metal hydroxide is 0.01% to 75% (wt.) of the total adhesive composition and releases water and the corresponding metal oxide when heated. The metal hydroxide may be at least one of aluminum hydroxide and magnesium hydroxide. The metal oxide is 0.01% to 80% (wt.) of the total adhesive composition and may be at least one of alumina, zinc oxide and magnesium oxide in the form of sheet-like (flakes), irregular or spherical shape.

The optional nitride may be 0.01% to 30% (wt.) of the total adhesive composition and may be a metal nitride or a non-metal nitride, such as at least one of aluminum nitride and boron nitride. The optional aluminum powder may be 0.01% to 3% (wt.) of the total adhesive composition.

The optional coupling agent may be a silane alone or mixed with a solvent. The optional coupling agent may be 0.01% to 5% (wt.) of the total adhesive composition and may be used alone or mixed with a solvent. In the siloxane resin, a cross-linking reaction of the siloxane resin is used to improve adhesion to enhance the adhesion between the siloxane resin and the silicon-free substrates.

In one embodiment of the present invention, the thermal conductive, electric insulating, high temperature resistant and flame retardant adhesive may further include at least one release film to cover at least one side of the adhesion composition. Preferably, when the thermal conductive, electric insulating, high temperature resistant and flame retardant adhesive is in the form of a double-sided adhesive, the release films respectively cover a first adhesion composition and a second adhesive composition of the adhesive.

In another embodiment of the present invention, the thermal conductive, electric insulating, high temperature resistant and flame retardant adhesive may be a single-sided adhesive product. The release film covers either one side of the adhesion composition.

In another embodiment of the present invention, the thermal conductive, electric insulating, high temperature resistant and flame retardant adhesive may further include a first adhesion composition and a second adhesive composition. The first adhesion composition covers a first side and the second adhesive composition covers a second side, so that the substrate is sandwiched between the first adhesive composition and the second adhesive composition.

In another embodiment of the present invention, the thermal conductive, electric insulating, high temperature resistant and flame retardant adhesive may be a single-sided adhesive product. The release film covers either one side of the adhesion composition so that the adhesion composition is sandwiched between the substrate and the release film.

In another embodiment of the present invention, the thermal conductive, electric insulating, high temperature resistant and flame retardant adhesive composition may be applied on the surface of a substrate or used alone without a substrate.

In another embodiment of the present invention, the thermal conductive, electric insulating, high temperature resistant and flame retardant adhesive composition has a thickness of from 0.5 mm to 20 mm.

In another embodiment of the present invention, the thermal conductive, electric insulating, high temperature resistant and flame retardant adhesive composition has a thermal resistance not greater than 5° C./watt.

In another embodiment of the present invention, the thermal conductive, electric insulating, high temperature resistant and flame retardant adhesive composition has a volume resistivity which is greater than 10⁸ (ohm-cm).

In another embodiment of the present invention, the thermal conductive, electric insulating, high temperature resistant and flame retardant adhesive composition is rated to the standard of the specification of UL 94V-0.

In another embodiment of the present invention, the substrate may have a thickness from 0.02 mm to 20 mm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the method to form a single-sided product of the adhesive composition of the present invention to go with a substrate.

FIG. 2 illustrates a single-sided product of extremely small thickness formed by the adhesive of the present invention.

FIG. 3 illustrates the adhesive of the present invention forms a single-sided adhesive product.

FIG. 4 illustrates the adhesives of the present invention form a double-sided adhesive of very small thickness without a substrate.

FIG. 5 illustrates the adhesive of the present invention forms a double-sided product with a substrate.

FIG. 6 illustrates the adhesive of the present invention forms a double-sided product with a substrate.

FIG. 7 illustrates the adhesive of the present invention forms a double-sided product with a substrate.

FIG. 8 illustrates the adhesive of the present invention forms a single-sided adhesive product which is compressible.

FIG. 9 illustrates the adhesives of the present invention forms a double-sided adhesive with a substrate.

### DETAILED DESCRIPTION

The present invention provides a thermal conductive, electric insulating, high temperature resistant and flame retardant composition and an adhesive containing the composition. The adhesive of the present invention contains at least a silicon oxide resin, a metal hydroxide and a metal oxide, and optional nitride or aluminum powder. In addition, a coupling agent based on silane is optionally employed when a silicon-free substrate is used.

The siloxane resin is used as the carrier for the high temperature resistant property, and the metal hydroxide as well as the metal oxide may be used to enhance the flame retardant property. At least one of the nitride and aluminum powder may be used to enhance the thermal conductive property. The coupling agent such as silane may be used alone or mixed with a solvent to form the chemical bonding with the silicon-free substrates to enhance the bonding strength. When the metal oxide is present in a higher ratio, it is possibly more thermal conductive and flame retardant. Preferably, the composition in the adhesive of the present invention may be not fully cured to be sufficiently sticky.

The siloxane resin may be 10% to 90% (wt.) of the overall adhesive composition, preferably from 20% to 50% by weight. These siloxane resins are materials which are able to withstand a temperature above 150° C. without substantially cracking at a temperature around 150° C., and its hardness does not substantially change with a change of the temperature. The term “substantially” used in the present invention is considered as the overall hardness change of the siloxane resin less than 10 degrees as the temperature changes, which meets the international standard of UL157 of O-ring and sealing gasket. In other words, the functions of the adhesive composition are not deteriorated accordingly. Supposing the change of the hardness of the thermoplastic material is within ±10 degrees, the function of the material is not compromised. The siloxane resin may be the products from USA Momentive (GE), USA Dow Corning or Japan Shin Etsu. For example, the Momentive series, which is used in pressure sensitive adhesives (PSA series), may be the siloxane resin for use in the present invention.

The metal hydroxide may be 0.01% to 75% (wt.) of the overall adhesive composition, preferably from 20% to 50% by weight. The metal hydroxide generates water and a corresponding metal oxide when heated. The metal hydroxide may be, for example, at least one of zinc hydroxide, aluminum hydroxide and magnesium hydroxide. The metal hydroxide helps to improve the flame retardant property of the overall adhesive composition.

The metal oxide may be 0.01% to 80% (wt.) of the overall adhesive composition, preferably from 20% to 50% by weight. The metal oxide may be a main group metal oxide or a transition metal oxide, such as at least one of alumina (aluminum oxide), zinc oxide and magnesium oxide. The metal oxide helps to improve the thermal conductive, flame retardant and electric insulating properties of the overall adhesive composition.

The optional nitride may be 0.01% to 30% (wt.) of the total adhesive composition, preferably from 10% to 20% by weight. The nitride may be a metal nitride, or a non-metal nitride, which helps to improve the thermal conductive property of the overall adhesive composition. For example, aluminum nitride or boron nitride may be added to the siloxane resin to make it more thermal conductive. The aluminum nitride has a thermal conductivity of 70-210 W/mK in the form of poly crystalline, and the single crystal boron nitride has a thermal conductivity about 100 W/mK.

The aluminum powder may be 0.01% to 3% (wt.) of the total adhesion composition, preferably from 0.5% to 1% by weight. The aluminum powder of high purity, high sphericity and less oxidized status may has an average particle size between 1 micrometer to 50 micrometer. The aluminum powder may have a heat transfer coefficient about 230 W/mK and helps to improve the thermal conductive property of the overall adhesion composition.

The optional coupling agent may be 0.01% to 5% (wt.) of the total adhesion composition, preferably from 1% to 3% by weight. The coupling agent mainly functions to enhance the interaction between the siloxane resin and a non-silicone substrate. The coupling agent may be a silane used alone such as from USA Momentive (GE), USA Dow Corning, Japan Shin Etsu or Germany Degussa AG, or a blended silane coupling agent with a solvent. The solvent may be toluene, xylene, isopropanol, butanone or ISOPAR®. The silane-based coupling agent may combine the two through the organic functional groups in the silane and a hydrolysis reaction of the non-silicone substrate. The cross-linking reaction helps to enhance the interaction between the siloxane resin and a non-silicone substrate.

After appropriately formulated, the adhesive composition of the present invention is thermal conductive, electric insulating, high temperature resistant and flame retardant at the same time. The formulation may be done by a closed mixer or an open mixer. The thermal resistance of the adhesive composition may be less than 5° C./w, and the thermal conductivity may be well adjusted in accordance with the addition of different ingredients. The volume resistivity of the adhesive composition is at least greater than 10⁸(ohm-cm), usually greater than 10¹¹ (ohm-cm), preferably greater than 10¹⁴ (ohm-cm). The adhesive composition of the present invention is rated to an international standard, such as the specification of UL 94V-0.

UL 94 V-0 is the international standard of flammability of plastic materials for parts in device and appliances. It rates the plastic and rubber flammability by judging the after flame time, burning rate and the falling flaming particles or drops. The details of UL 94V-0 are available to the public. Please refer to the specification of UL 94V-0.

Optionally, the adhesive composition as well as the adhesive of the present invention may have an extremely small thickness. For example, the thickness of the adhesion composition may be between 0.05 mm to 20 mm, typically between 0.5 mm to 0.05 mm, preferably between 0.2 mm to 0.05 mm. Therefore, the adhesive composition of the present invention may form a single-sided or a double-sided product of extremely small thickness.

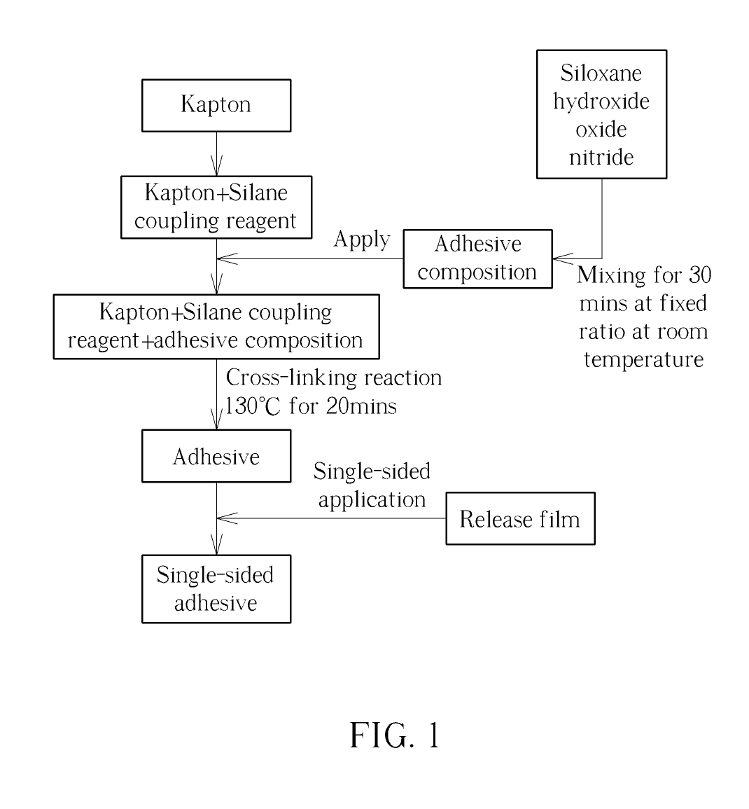

FIG. 1 illustrates the method to form a single-sided product of the adhesive composition of the present invention to go with a substrate, such as Kapton®. First, a layer of silane coupling agent is applied on one side of a Kapton® substrate and dried at room temperature. After that, a layer of adhesive composition of the present invention which has been pre-formulated is uniformly applied on the silane coupling agent. The adhesive composition of the present invention may have, for example 50% siloxane resin, 30% alumina, 18% of aluminum nitride and 2% silicon silane coupling agent. Next, it is placed in an oven at 130° C. for 20 minutes to undergo a cross-linking reaction. Afterwards, it is taken out and a release film is applied on.

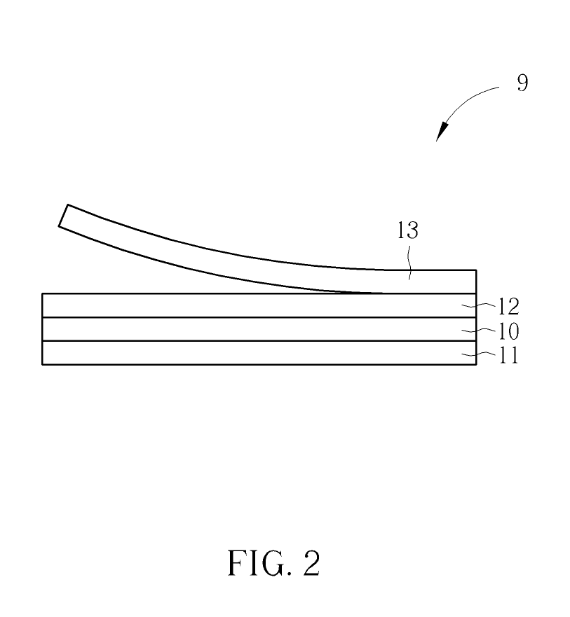

In one embodiment of the present invention, the adhesive of the present invention may form a single-sided product of extremely small thickness. FIG. 2 illustrates a single-sided product of extremely small thickness formed by the adhesive of the present invention. The adhesive 9 of the present invention includes a substrate 11, an adhesive composition 12 and a release film 13. The element 10 is a silane-containing coupling agent. The substrate 11 may be a metal foil of excellent thermal conductive property, such as aluminum foil. Please refer to the above for the details of the adhesive composition 12. The total thickness of the substrate 11 and the adhesive composition 12 can be as small as about 0.05 mm. The coupling agent 10 helps to strengthen the adhesion between the adhesive composition 12 and the non-silicone substrate 11.

The adhesive composition 12 covers one side of the substrate 11, and the release film 13 covers the other side of the adhesion composition 12, so that the adhesion composition 12 is sandwiched between the substrate 11 and the release film 13. Tear the release film 13 off to adhere the adhesive composition 12 to a target object (not shown). FIG. 2 illustrates the adhesives 9 of the present invention, which has the substrate 11 of excellent thermal conductivity property, particularly suitable for a heat source of continuous high temperature and for use in high thermal conductive purposes, such as the motherboards of computers, central processor units or power supplies to bind the heat source and the heat sink.

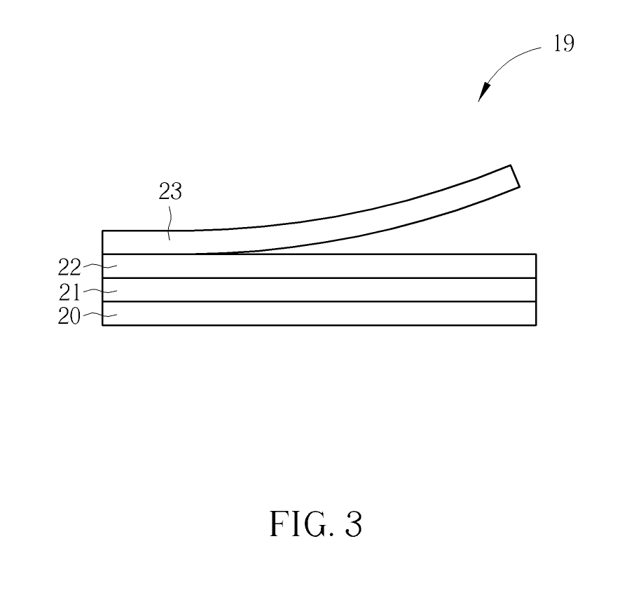

In another embodiment of the present invention, the adhesive of the present invention may form another single-sided adhesive product. FIG. 3 illustrates the adhesive of the present invention forms a single-sided adhesive product. The adhesive 19 of the present invention includes a substrate 20, an adhesive composition 22 and a release film 23. The element 21 is a silane-containing coupling agent. The substrate 20 may be an organic polymer, preferably a thermal stable, high electric resistant and robust organic polymer, for example Kapton®, which is basically a polyimide (PI) insulating film or tape, a trademark of DuPont Inc. Kapton® is highly flexible, puncture-proof, and has good electrical properties. Alternatively, other commercially available polyimide materials will do, too. If the substrate is required to withstand a temperature no more than 80° C. to 150° C., commercially available polyethylene terephthalate (PET) or polycarbonate (PC) material may be considered as the substrate. Please refer to the above for the details of the adhesive composition 22. The coupling agent 21 helps to strengthen the adhesion between the adhesive composition 22 and the non-silicone substrate 20.

The adhesive composition 22 covers one side of the substrate 20, while the release film 23 coves the other side of the adhesive composition 22, so that the adhesive composition 22 is sandwiched between the substrate 20 and the release film 23. Tear the release film 23 off to adhere the adhesive composition 22 to a target object (not shown). FIG. 3 illustrates the adhesives 19 of the present invention, which has the substrate 21 of high tensile strength, high tearing strength and withstand voltage property, is particularly suitable for the high voltage and high temperature purposes.

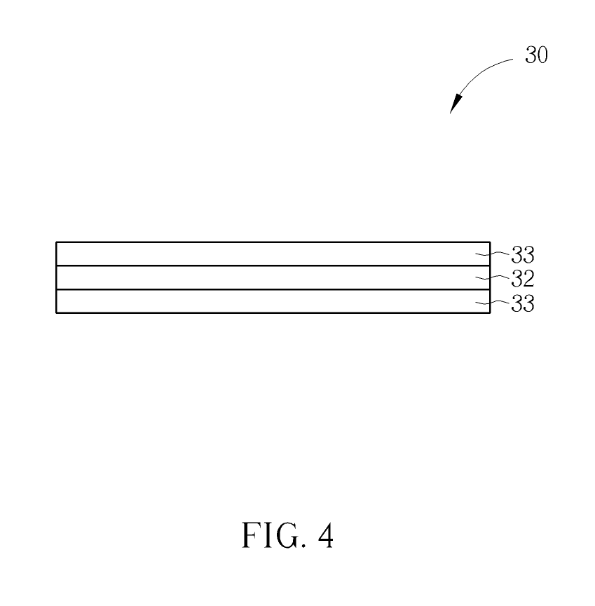

In another embodiment of the present invention, the adhesive of the present invention may form a single-sided adhesive product of a minimum thickness. FIG. 4 illustrates the adhesives of the present invention form a double-sided adhesive of very small thickness without substrate. The adhesive 30 of the present invention may contain nothing but an adhesion composition 32 and completely go without a substrate. The presence of the release film 33 is optional. Please refer to the above for the details of the adhesion composition 32.

The release films 33 cover both sides of the adhesive composition 32 so that the adhesive composition 32 is sandwiched between the release films 33. Tear the release film 33 off to adhere the adhesive composition 32 to a target object (not shown). FIG. 4 illustrates the adhesive 30 of the present invention to completely omit the thickness of a substrate, and particularly suitable for use in limited space.

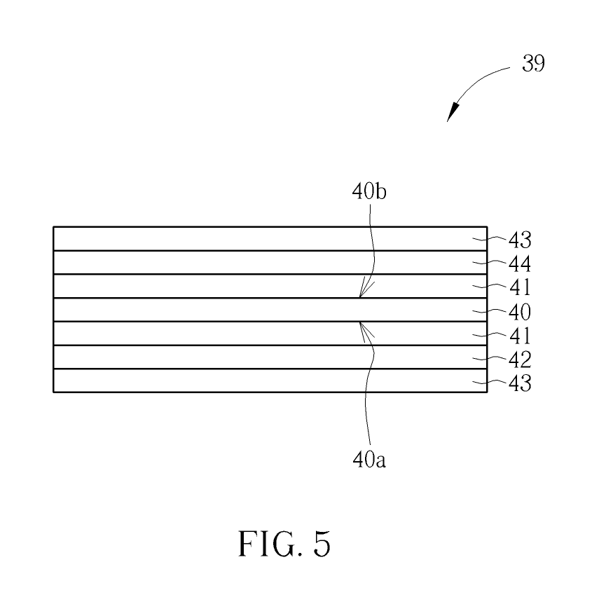

In another embodiment of the present invention, the adhesive of the present invention may also form a double-sided product with a substrate. FIG. 5 illustrates the adhesive of the present invention forms a double-sided product with a substrate. The adhesive 39 of the present invention includes a substrate 40, a first adhesive composition 42, a second adhesive composition 44 and a release film 43. The element member 41 is a silane-containing coupling agent. The substrate 40 may be a metal foil of excellent thermal conductive property, such as aluminum foil. Please refer to the above for the details of the first adhesive composition 42 and the second adhesive composition 44. The coupling agent 41 helps to strengthen the adhesion between the first adhesive composition 42 as well as the second adhesive composition 44 and the non-silicone substrate 40.

The first adhesive composition 42 and the second adhesive composition 44 respectively cover the first side 40a and the second side 40b of the substrate 40, so that the substrate 40 is sandwiched between the first adhesive composition 42 and the second adhesive composition 44. The release films 43 cover both the first adhesive composition 42 and the second adhesive composition 44 at the same time so that the substrate 40, the first adhesive composition 42 and the second adhesive composition 44 are also sandwiched between the release films 43. Tear the release film 43 off to respectively adhere the first adhesive composition 42 and the second adhesive composition 44 to a target object (not shown). FIG. 5 illustrates the adhesive 39 of the present invention, which has the substrate 40 of excellent thermal conductivity property, particularly suitable for a heat source of continuous high temperature and for use in high thermal conductive purposes, such as the motherboards of computers, central processor units or power supplies to bind the heat source and the heat sink.

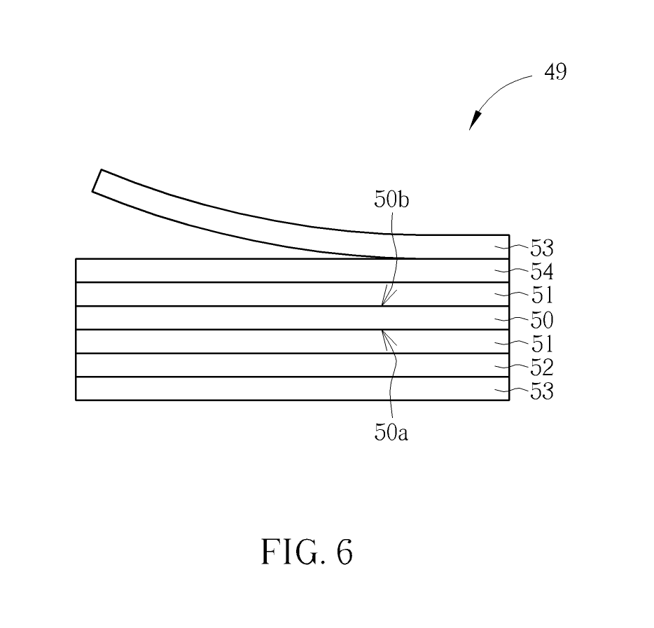

In another embodiment of the present invention, the adhesive of the present invention may also form a double-sided adhesive product with a substrate. FIG. 6 illustrates the adhesive of the present invention forms a double-sided product with a substrate. The adhesive 49 of the present invention includes a substrate 50, a first adhesive composition 52, a second adhesive composition 54 and a release film 53. The element 51 is a silane-containing coupling agent. The substrate 50 may be an organic polymer, preferably a thermal stable, high electric resistant and robust organic polymer, for example Kapton®, which is basically a polyimide (PI) insulating film or tape, a trademark of DuPont Inc. Kapton® is highly flexible, puncture-proof, and has good electrical properties. Alternatively, other commercially available polyimide materials will do, too. If the substrate is required to withstand a temperature no more than 80° C. to 150° C., commercially available polyethylene terephthalate (PET) or polycarbonate (PC) material may be considered as the substrate. Please refer to the above for the details of the first adhesive composition 52 and the second adhesive composition 54. The coupling agent 51 helps to strengthen the adhesion between the first adhesive composition 52 as well as the second adhesive composition 54 and the non-silicone substrate 50.

The first adhesive composition 52 and the second adhesive composition 54 respectively cover the first side 50a and the second side 50b of the substrate 50, so that the substrate 50 is sandwiched between the first adhesive composition 52 and the second adhesive composition 54. The release films 53 cover both the first adhesive composition 52 and the second adhesive composition 54 at the same time so that the substrate 50, the first adhesive composition 52 and the second adhesive composition 54 are also sandwiched between the release films 53. Tear the release film 53 off to respectively adhere the first adhesive composition 52 and the second adhesive composition 54 to a target object (not shown). FIG. 6 illustrates the adhesive 49 of the present invention, which has the substrate 50 of high tensile strength, high tearing strength and withstand voltage property, is particularly suitable for the high voltage and high temperature purposes.

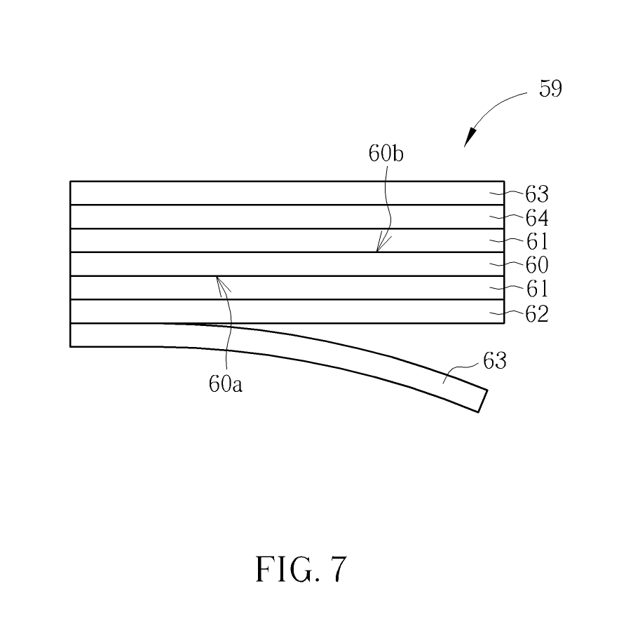

In another embodiment of the present invention, the adhesive of the present invention may also form a double-sided adhesive product with a substrate. FIG. 7 illustrates the adhesive of the present invention forms a double-sided product with a substrate. The adhesive 59 of the present invention includes a substrate 60, a first adhesive composition 62, a second adhesive composition 64 and a release film 63. The element 61 is a silane-containing coupling agent. The substrate 60 may be an inorganic material, preferably glass fiber. Glass fiber is dimensionally stable under high temperature, electrical resistant, flame retardant, and robust. Please refer to the above for the details of the first adhesive composition 62 and the second adhesive composition 64. The coupling agent 61 helps to strengthen the adhesion between the first adhesive composition 62 as well as the second adhesive composition 64 and the non-silicone substrate 60.

The first adhesive composition 62 and the second adhesive composition 64 respectively cover the first side 60a and the second side 60b of the substrate 60, so that the substrate 60 is sandwiched between the first adhesive composition 62 and the second adhesive composition 64. The release films 63 cover both the first adhesive composition 62 and the second adhesive composition 64 at the same time so that the substrate 60, the first adhesive composition 62 and the second adhesive composition 64 are also sandwiched between the release films 63. Tear the release film 63 off to respectively adhere the first adhesive composition 62 and the second adhesive composition 64 to a target object (not shown). FIG. 7 illustrates the adhesive 59 of the present invention is particularly for use as strips because the substrate 60 is dimensionally stable under high temperature, electrical resistant, flame retardant, and robust.

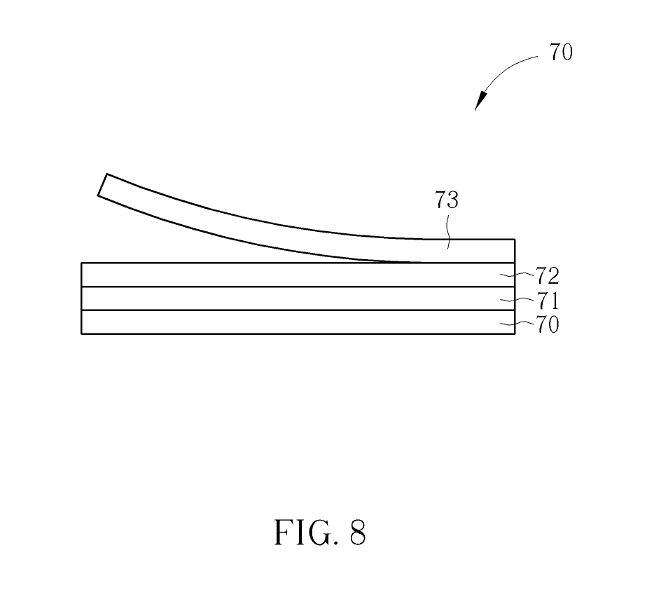

In another embodiment of the present invention, the adhesive of the present invention may form a compressible single-sided adhesive. FIG. 8 illustrates the adhesive of the present invention forms a single-sided adhesive product. The adhesive 70 of the present invention includes a substrate 71, an adhesive composition 72 and a release film 73. The substrate 71 may be a thermal conductive, flame retardant and electric insulating silicone sheet of different hardness. The main component of this thermally conductive silicone sheet may be a siloxane resin, and other additives, such as ceramic powder, are added to be thermal conductive. In this way, the thermal conductive silicone sheet is flexible and, not sticking foreign particles, and closely in contact with the heat source to improve the thermal conductive effect. The substrate 71 may have a thickness between 0.5 mm to 20 mm. Please refer to the above for the details of the adhesive compositions 72.

The adhesive composition 72 covers one side of the substrate 71, and the release film 73 covers the other side of the adhesive composition 72, so that the adhesive composition 72 is sandwiched between the substrate 71 and the release film 73. Tear the release film 73 off to adhere the adhesive composition 72 to a target object (not shown). FIG. 8 illustrate the compressible, flexible, temperature resistant and electric insulating adhesive 70 of the present invention to be particularly suitable in contact with a heating source whose surface may not be even, such as IC chips.

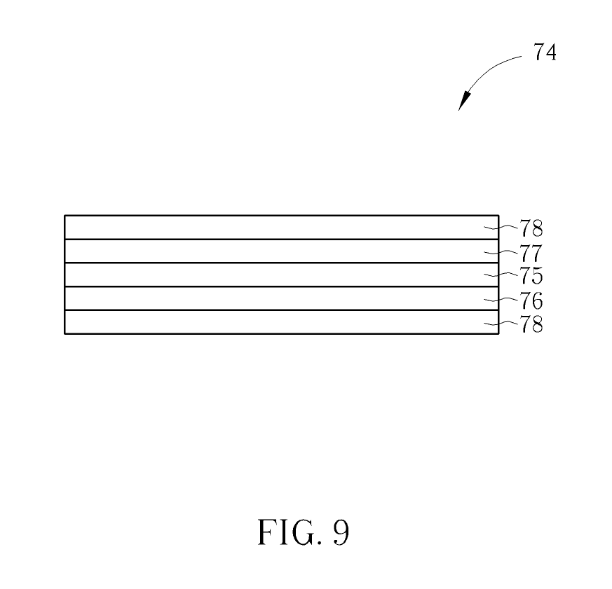

In another embodiment of the present invention, the adhesive of the present invention may form a double-sided adhesive with a substrate. FIG. 9 illustrates the adhesives of the present invention forms a double-sided adhesive with a substrate. The adhesive 74 of the present invention includes a substrate 75, a first adhesive composition 76, a second adhesive substance 77 and a release film 78. The substrate 75 may be a thermal conductive, flame retardant and electric insulating silicone sheet of different hardness. The main component of this thermally conductive silicone sheet may be a siloxane resin, and other additives, such as ceramic powder, are added to be thermal conductive. In this way, the thermal conductive silicone sheet is flexible and, not sticking foreign particles, and closely in contact with the heat source to improve the thermal conductive effect.

The compressible, flexible, temperature resistant and electric insulating adhesive 74 of the present invention is particularly for use in assembling electronic products or in a heating source whose surface may not be even. Please refer to the above for the details of the adhesive compositions 72. Tear the release film 73 off to adhere the adhesive composition 72 to a target object (not shown). Due to its superior adhesion, the target object would not come off or dislocate during transportation or being fetched after the adhesive composition adheres to a target object.

Table 1 summarizes the properties of the single-sided or double-sided adhesives of the present invention formed by the adhesion composition of the present invention with various substrates, in particular low thermal resistance, high temperature resistance, high flame resistance and high voltage resistance. The adhesion composition of the present invention is thermal conductive, electric insulating, high temperature resistant and flame retardant.

TABLE 1

| | | | | | | Test |
|---|---|---|---|---|---|---|
| | EXAMPLE 1 | EXAMPLE 2 | EXAMPLE 3 | EXAMPLE 4 | EXAMPLE 5 | mode |
| substrate | Fiber | Aluminum | — | Kapton ® | siloxane | |
| | glass | foil | | | resin | |
| thickness | 0.1 +/− 0.05 | 0.05~0.25 | 0.05~20 | 0.02~0.15 | 0.1~20 | Thickness |
| (mm) | | | | | | meter |
| form | single/ | single/ | single/ | single/ | single/ | |
| | double-sided | double-sided | double- | double-sided | double- | |
| | | | sided | | sided | |
| Holding | above 250 | above 250 | above 1 | above 250 | above 1 | ASTM D |
| strength | | | | | | 1000 |
| gf/in² | | | | | | |
| Thermal | below 5 | below 0.6 | below 5 | below 3.5 | below 5 | ASTM D |
| resistance | | | | | | 5470 |
| (° C. | | | | | | |
| in/watt) | | | | | | |
| volume | above 108 | | above | above 108 | above | ASTM D |
| resistivity | | | 108 | | 108 | 257 |
| (ohm- | | | | | | |
| cm) | | | | | | |
| Breakdown | above 2.0 | | 0.5 | above 5 | 0.5 | ASTM D |
| Voltage | | | | | | 149 |
| (kV) | | | | | | |
| Tensile | above 150 | above | | above 250 | | ASTM D |
| Strength | | 12 | | | | 412 |
| (Kgf/cm²) | | | | | | |
| (Elongation) | above 2 | above 5 | | above 20 | | ASTM D |
| (%) | | | | | | 412 |
| Operating | −40~180 | −40~180 | −40~180 | −40~180 | −40~180 | |
| temperature | | | | | | |
| (° C.) | | | | | | |
| UL | 94V-0 | 94V-0 | 94V-0 | 94V-0 | 94V-0 | UL No. |
| flammability | | | | | | E153203 |
| RoHS | pass | pass | pass | pass | pass | SGS |
| | | | | | | ICP |
| Halogen | pass | pass | pass | pass | pass | SGS |
| content | | | | | | |

In brief, the adhesive of the present invention has the following advantages:

1. Comply with the international standards of UL 94 V-0.
2. Re-workable, re-stickable even after a long period of use.
3. High thermal conductivity (thermal resistance of less than 5° C./Watt) and long-term resistance to high temperature (−40° C. to 150° C.)
4. Insoluble in water, non-hydrolysis, resistant to UV light, sweat, cosmetics and etc.
5. Both single or double-sided products possible, high temperature resistant and flame retardant when in use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thermal conductive, electric insulating, high temperature resistant and flame retardant adhesive, comprising:
a substrate; and
an adhesive composition, comprising:
a siloxane resin of 10% to 90% (wt.), which are temperature resistant above 150° C. without substantially cracking under at 150° C., and whose hardness does not change with a change of temperature;
a metal hydroxide of 0.01% to 75% (wt.); and
a metal oxide of 0.01% to 80% (wt.).

2. The thermal conductive, electric insulating, high temperature resistant and flame retardant adhesive of claim 1, further comprising:
a nitride of 0.01% to 30% of (wt.).

3. The thermal conductive, electric insulating, high temperature resistant and flame retardant adhesive of claim 1 further comprising:
aluminum powder of 0.01% to 3% (wt.).

4. The thermal conductive, electric insulating, high temperature resistant and flame retardant adhesive of claim 1 further comprising:
a coupling agent of 0.01% to 5% (wt.).

5. The thermal conductive, electric insulating, high temperature resistant and flame retardant adhesive of claim 1, wherein said metal hydroxide comprises at least one of aluminum hydroxide and magnesium hydroxide.

6. The thermal conductive, electric insulating, high temperature resistant and flame retardant adhesive of claim 5, wherein an average particle size of said metal hydroxide is 0.1 to 100 μm.

7. The thermal conductive, electric insulating, high temperature resistant and flame retardant adhesive of claim 1, wherein said metal oxide is selected from the group consisting of at least one of sheet-like, irregular or spherical alumina, zinc oxide and magnesium oxide.

8. The thermal conductive, electric insulating, high temperature resistant and flame retardant adhesive of claim 7, wherein said metal oxide has an average particle size of 0.1 μm to 100 μm.

9. The thermal conductive, electric insulating, high temperature resistant and flame retardant adhesive of claim 2, wherein said nitride is at least one of aluminum nitride and boron nitride.

10. The thermal conductive, electric insulating, high temperature resistant and flame retardant adhesive of claim 9, wherein said nitride has an average particle size of 0.5 to 300 μm.

11. The thermal conductive, electric insulating, high temperature resistant and flame retardant adhesive of claim 3, wherein said aluminum powder is less than 3% of said adhesive composition and has an average particle size of 1 to 20 μm.

12. The thermal conductive, electric insulating, high temperature resistant e and flame retardant adhesive of claim 4, wherein said coupling agent comprises silane as an adhesion enhancer when a silicon-free substrate is present, and said coupling agent makes a cross-linking reaction possible between the interface of said siloxane resin and said substrate to have an adhesive function when said siloxane resin goes with said substrate which is silicon-free.

13. The thermal conductive, electric insulating, high temperature resistant and flame retardant adhesive of claim 1, further comprising:
at least one release film to cover at least one side of said adhesion composition.

14. The thermal conductive, electric insulating, high temperature resistant and flame retardant adhesive of claim 1, when said adhesive is in the form of a double-sided adhesive further comprising:
a substrate having a first side and a second side;
a first said adhesion composition covering said first side; and
a second said adhesive composition covering said second side, so that said substrate is sandwiched between said first adhesive composition and said second adhesive composition.

15. The thermal conductive, electric insulating, high temperature resistant and flame retardant adhesive of claim 14, wherein said substrate is a metal foil.

16. The thermal conductive, electric insulating, high temperature resistant and flame retardant adhesive of claim 14, wherein said substrate is glass fiber.

17. The thermal conductive, electric insulating, high temperature resistant and flame retardant adhesive of claim 14, wherein said substrate is an organic polymer.

18. The thermal conductive, electric insulating, high temperature resistant and flame retardant adhesive of claim 14, wherein said substrate is a thermally conductive silicone sheet.

19. The thermal conductive, electric insulating, high temperature resistant and flame retardant adhesive of claim 13, when said adhesive is in the form of a single-sided adhesive further comprising:
a substrate covering a first side of said adhesion composition;
said release film covering a second said of said adhesion composition so that said adhesion composition is sandwiched between said substrate and said release film.

20. The thermal conductive, electric insulating, high temperature resistant and flame retardant adhesive of claim 19, wherein said substrate is a metal foil.

21. The thermal conductive, electric insulating, high temperature resistant and flame retardant adhesive of claim 19, wherein said substrate is an organic polymer.

22. The thermal conductive, electric insulating, high temperature resistant and flame retardant adhesive of claim 19, wherein said substrate is a glass fiber.

23. The thermal conductive, electric insulating, high temperature resistant and flame retardant adhesive of claim 19, wherein said substrate is a thermally conductive silicone sheet.

24. The thermal conductive, electric insulating, high temperature resistant and flame retardant adhesive of claim 1, wherein a thickness of said adhesive composition ranges from 0.5 mm to 20 mm.

25. The thermal conductive, electric insulating, high temperature resistant and flame retardant adhesive of claim 1, wherein said adhesive composition has a thermal resistivity not greater than 5° C./watt.

26. The thermal conductive, electric insulating, high temperature resistant and flame retardant adhesive of claim 1, wherein said adhesive composition has a volume resistivity greater than 10⁸ (ohm-cm).

27. The thermal conductive, electric insulating, high temperature resistant and flame retardant adhesive of claim 1, wherein said adhesive composition is rated to the standard of UL 94V-0.
